(19) United States
(12) Patent Application Publication
(10) Pub. No.: US 2021/0035094 A1
(43) Pub. Date: Feb. 4, 2021

(54) LEGITIMACY MANAGEMENT SYSTEM, LEGITIMACY MANAGEMENT METHOD, AND PROGRAM

(71) Applicant: Real Technology Inc., Kanagawa (JP)

(72) Inventors: Hiroyuki OZAKI, Kanagawa (JP); Kazuaki YOKOYAMA, Hyogo (JP)

(21) Appl. No.: 16/976,253

(22) PCT Filed: Feb. 28, 2019
(86) PCT No.: PCT/JP2019/007843

§ 371 Date: Aug. 27, 2020

(30) Foreign Application Priority Data
Feb. 28, 2018 (JP) 2018-035659

(51) Int. Cl. G06Q 20/38; G06F 16/13; G06Q 20/06; G06Q 20/36; G06Q 30/00; G06Q 40/04; G06Q 20/22; H04L 9/32; G06Q 10/10

(52) U.S. Cl. CPC G06Q 20/389; G06F 16/13; G06Q 20/0655; G06Q 20/3674; G06Q 30/0185; G06Q 40/04; G06Q 20/3829; H04L 9/32; G06Q 10/10; G06Q 20/3827; H04L 2209/56; G06Q 2220/00; G06Q 20/223

(57) ABSTRACT

A legitimacy management system or the like is provided, configured to be suitable for managing history information with legitimacy ensured giving consideration to security. A legitimacy management system 1 includes a user device 3, distribution device 5, and exchange apparatus 7. A splitting engine and combining engine are separately managed by user device 3 and exchange apparatus 7, respectively. User device 3 includes a splitting unit 21. Exchange apparatus 7 includes a combining unit 51. User device 3 instructs splitting unit 21 to split history information into multiple split files, and distributes the split files to user device 3 and the distribution device 5. When the history information is updated, user device 3 issues a request to exchange apparatus 7. In this case, combining unit 51 of exchange apparatus 7 combines the split files to acquire a combined file, and sends the combined file to user device 3.

### TECHNICAL FIELD

The present invention relates to a legitimacy management system, a legitimacy management method, and a program, and particularly to a legitimacy management system or the like that manages history information that indicates the history of processing with respect to a user.

### BACKGROUND ART

At present, the technique disclosed in Non-patent document 1 has become a de facto standard in the technical field of cryptocurrency.

The present applicant has proposed a technique disclosed in Patent document 1. That is to say, with regard to the combination of split ciphertext data and split key data, rather than designing each piece so as to be “equal”, by generating combinations of equal and unequal pieces of split ciphertext data and split key data, this provides a novel technique for supporting confidentiality.

### CITATION LIST

### Patent Literature

### [Patent Document 1]

Japanese Patent Application Laid Open No. 2017-130720

### [Non-Patent Document 1]

S. Nakamoto, “Bitcoin: A Peer-to-Peer Electronic Cash System”, [online], Internet

<URL:http://nakamotoinstitute.org/bitcoin/>

### SUMMARY OF INVENTION

### Technical Problem

In order to provide the technique described in Non-patent document 1, transactions (dealings with respect to payment or billing) is broadcasted to a P2P network without involving a central administrator (financial institution). Furthermore, by employing a blockchain technique, this arrangement detects past falsification (insufficient funds, malicious duplicate payment, etc.). In some cases, the entire blockchain is referred to as a “ledger”.

In a case of employing such a blockchain technique, this arrangement is capable of detecting falsification or the like in a simple manner. However, recently, such falsification detection requires an enormous verification time. Furthermore, the emergence of quantum computers or the like leads to a large difference in the verification time. This leads to a problem in that falsified data can be justified, which has become a clear problem. Moreover, in the technical field of cryptocurrency, development is focused on node protocol accumulation. That is to say, cryptocurrency is used with almost no security measures for the client.

It should be noted that almost all other kinds of virtual currencies are designed with reference to improvements on bitcoin (BTC). Ripple is a commission-based central management system employing a private blockchain. Ripple breaks down the decentralized management and mining that are features of BTC. However, Ripple is not an innovative system that supersedes BTC.

The present inventor has analyzed a problem that occurs in the BTC system. As a result, it has been understood that this problem is due to it being premised on the elimination of a central administrator. The P2P network system has a main advantage of allowing users to perform their processing via a P2P network without involving a central server in a case in which access or processing is concentrated on the central server. However, with current arrangements, each ordinary user creates a client-server relation between the user and an exchange. After the user is registered in the exchange, the user conducts transactions using a downloaded wallet. Ideally, such a P2P processing system contributes an advantage in load distribution to each ordinary user. In actuality, such a system has not been realized.

An important problem to be solved is not to support data management without involving a central administrator, but rather to provide a technique for preventing falsification. Such a problem is not restricted to the technical field of cryptocurrency. Other kinds of data processing have the same problem.

Patent document 1 relates to a novel method for maintaining confidentiality.

Accordingly, it is a purpose of the present invention to provide a legitimacy management system or the like that is suitable for managing history information with legitimacy ensured giving consideration to security.

### Solution of Problem

A first aspect of the present invention relates to a legitimacy management system configured to manage history information that indicates a processing history with respect to a user. The legitimacy management system includes: a user device; a distribution device; an exchange apparatus; and an authentication unit. The user device includes: a splitting unit configured to split the history information so as to acquire multiple split files; and a processing unit configured to issue a combining request for instructing the exchange apparatus to perform combining processing. The distribution device includes a split file storage unit configured to store a part or all of the multiple split files. The exchange apparatus includes: a combining unit configured to receive at least one split file from the distribution device, and to perform combining processing of a part or all of the multiple split files so as to acquire a combined file, according to the combining request. The authentication unit judges whether or not falsification has occurred in the combined file in a period of time from the splitting processing up to the combining processing. When the authentication unit has judged that no falsification has been detected in the combined file, the processing unit adds a new processing history to the combined file, which is employed as new history information.

A second aspect of the present invention relates to the legitimacy management system according to the first aspect. The user devices include a sending device configured to send a message and a receiving device configured to receive the message. The authentication unit verifies the message beforehand. When judgement has been made that the message is legitimate, the processing unit of the sending device sends the message, and adds a history of the message sending processing to the combined file that corresponds to the sending device, and the processing unit of the receiving device receives the message, and adds a history of the message receiving processing to the combined file that corresponds to the receiving device.

A third aspect of the present invention relates to the legitimacy management system according to the first or second aspect. The multiple split files include a privileged split file having a structure that allows the combining unit to use the privileged split file only once to perform the combining processing, and an ordinary split file that allows the combining unit to use the ordinary split file multiple times to perform the combining processing. The splitting unit stores a part or all of the ordinary split files in the distribution device, instructs the user device to hold the privileged split file, and instructs the distribution device not to hold the privileged split file. The combining unit receives the privileged split file from the user device, receives at least one ordinary split file from the distribution device, and performs the combining processing using the privileged split file and at least one ordinary split file.

A fourth aspect of the present invention relates to a legitimacy management method for managing history information that indicates a processing history with respect to a user. The legitimacy management method includes: splitting in which a splitting unit included in a user device splits the history information so as to acquire multiple split files; storing in which a split file storage unit included in a distribution device stores a part or all of the multiple split files; combined file acquiring in which a processing unit included in the user device issues a combining request for instructing an exchange apparatus to perform combining processing, a combining unit included in the exchange apparatus receives at least one split file from the distribution device, and performs combining processing of a part or all of the multiple split files so as to acquire a combined file, according to the combining request; and new history information generating in which an authentication unit judges whether or not falsification has occurred in the combined file in a period of time from the splitting processing up to the combining processing, and when the authentication unit has judged that no falsification has been detected in the combined file, the processing unit adds a new processing history to the combined file, which is employed as new history information.

A fifth aspect of the present invention relates to a computer program configured to instruct a computer to function as a splitting unit according to any one of the first through third aspects, or as an authentication unit according to any one of the first through third aspects. It should be noted that the present invention may be regarded as a computer-readable recording medium that records the program according to the fifth aspect.

It should be noted that the authentication unit may be configured to judge the presence or absence of falsification using a hash value or the like. Also, the authentication unit may be configured to verify in the splitting processing whether or not the combining processing can be performed for a part of or all the the split files. Also, in the message sending/receiving processing, the sender-side authentication unit and the receiver-side authentication unit may each be configured to send a notice of a verification result to the other authentication unit, in addition to being configured to verify whether or not there is falsification in the corresponding combined file in the message sending/receiving processing, and to verify whether or not the combining processing can be performed for a part of or all the split files of the new history information.

Also, the user device and the exchange apparatus may each be configured to store the history information, combined file, etc., during processing, and not to store such information after the processing. For example, the user device and/or the exchange apparatus may each be configured to instruct its main storage device to store the history information or the like required for the processing, without writing such information to its auxiliary storage device. That is to say, such an arrangement may enable only temporary writing such as cache memory writing or the like in the processing without involving nonvolatile writing (continuous writing). With such an arrangement, the history information or the like is not held after the processing. Also, the user device and the distribution device may each be configured to store the split file in the auxiliary storage device or the like in order to hold the split file after the processing.

### Advantageous Effects of Invention

With each aspect of the present invention, an exchange apparatus and an authentication unit are introduced. This system allows the user to make a contract with an “authentication authority” configured as an authentication unit in order to verify that there has been no falsification in the user's history information from the past up to the current time. This arrangement requires no “mining”, thereby involving no excessive competition between miners. Furthermore, each user device includes a splitting engine and no combining engine. In contrast, each exchange apparatus includes a combining engine and no splitting engine. The history information (history file, ledger, or the like) is distributed in a secret-sharing manner to the distribution devices having no stake in the user device, each configured as a third-party device, for example. In contrast, the exchange apparatus includes no splitting engine. Accordingly, the exchange apparatus is capable of combining the split files distributed in a secret-sharing manner. However, the exchange apparatus is not capable of storing falsified history information in the form of split files even if the exchange apparatus falsifies the history information. This provides a system configured such that the user devices and the exchange apparatuses operate while restraining each other, thereby protecting the history information from being falsified by a single device alone.

In particular, with a technique described in Non-patent document 1, a method for storing a private key managed by the user is not defined. With such an arrangement, if the private key has been lost, the private key cannot be restored. In contrast, with each aspect of the present invention, a management system may be employed in which the history information cannot be combined based on the split files if the user device is damaged, as with conventional techniques. Also, another management system may be employed in which the history information can be combined based on the split files even if the user device is damaged.

In addition, with each aspect of the present invention, each distribution device supports data storage or the like using its storage area, for example. Accordingly, various kinds of IoT devices (home electronics appliances such as refrigerators, ovens, etc.) may each be employed as the distribution device. It should be noted that, with the management system according to the present invention, a storage charge may be paid for each storage space provided by the clients (user deices, distribution devices, devices each having both the user device function and the distribution device function, etc.). As described above, this system is capable of effectively using storage space remaining in devices worldwide. In particular, such a system manages the history information for every user per each user. Accordingly, such a system involves only a very small amount of data to be stored, as compared with the technique described in Non-patent document 1 or the like. It should be noted that, in a case in which individual history information becomes large with the passage of time, such a system may employ a technique in which the individual history information (in part or in whole) is managed in a “fixed” form using a blockchain technique. That is to say, the present invention by no means eliminates such a technique for managing the individual history information in a “fixed” form using a blockchain technique.

In addition, with a second aspect of the present invention, such a system supports message communication between the user devices using a P2P mechanism alone. This allows each user device to benefit from the advantage in employing the P2P mechanism without involving a central server or the like. That is to say, from the viewpoint of the cryptocurrency technical field, each transaction is directly sent from a wallet to another wallet. Accordingly, each exchange apparatus is not able to falsify a transaction.

In addition, with a third aspect of the present invention, the split files include the privileged split file (privileged piece) in addition to the ordinary split files. With such an arrangement, an exchange apparatus is configured such that it cannot perform the combining processing without using the privileged piece, for example. Furthermore, by appropriately managing the privileged piece in the user device, this arrangement is capable of preventing the occurrence of information leakage or the like in the exchange apparatus. In addition, even if a given ordinary split file has been falsified or a bit has been dropped during communication of a given ordinary split file, other ordinary split files can be used to perform the combining processing.

### BRIEF DESCRIPTION OF DRAWINGS

FIG. 1 is a diagram showing an example configuration of a legitimacy management system 1 according to an embodiment of the present invention.

FIG. 2 is a diagram showing an example of the operation of the legitimacy management system 1 shown in FIG. 1.

FIG. 3 is a diagram for explaining an example of history information management in information processing with respect to multiple users.

### DESCRIPTION OF EMBODIMENTS

Description will be made below with reference to the drawings regarding an example of the present invention. It should be noted that an embodiment of the present invention is not restricted to such an example described below.

### EXAMPLE 1

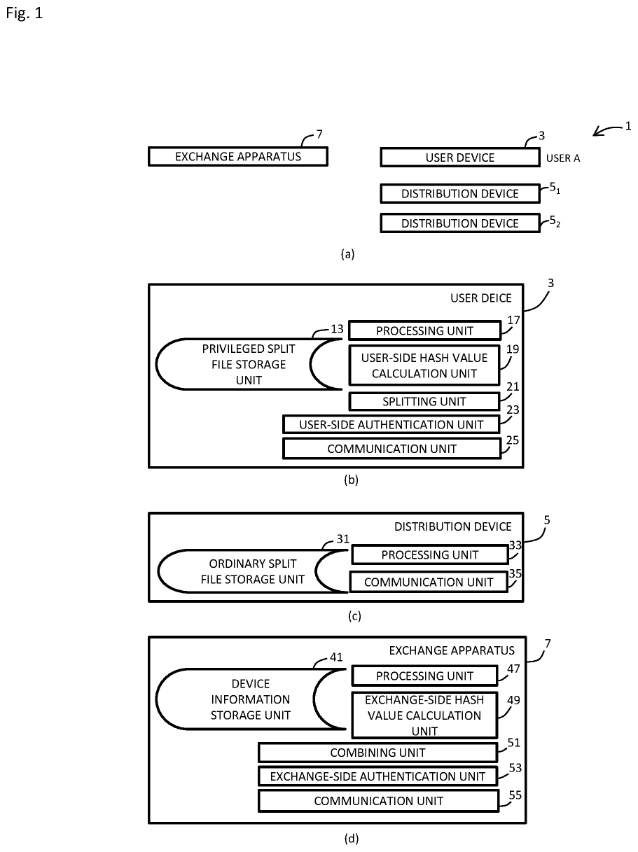

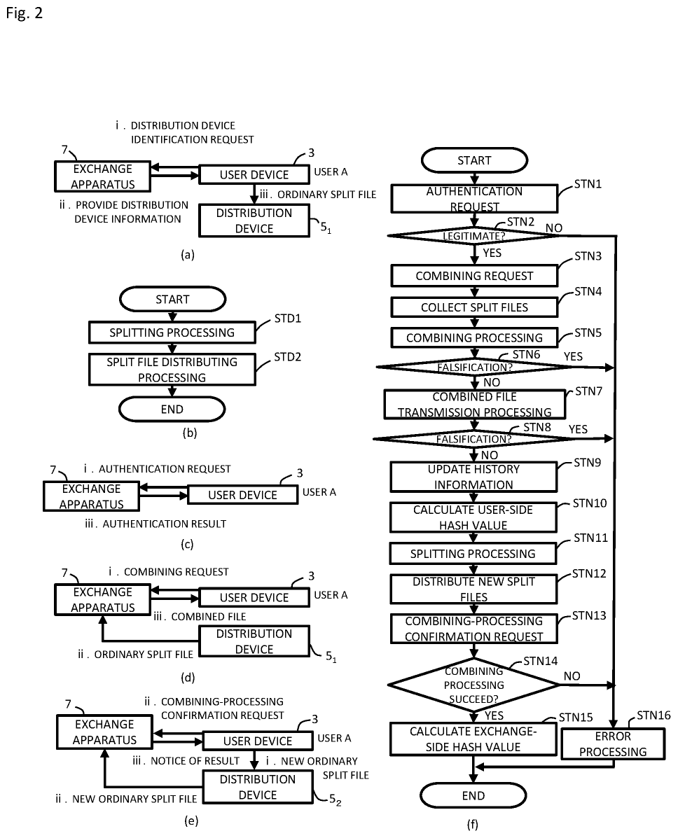

FIGS. 1 and 2 are diagrams showing a configuration of and processing by a legitimacy management system 1 according to an example of an embodiment of the present invention, respectively.

The legitimacy management system 1 shown in FIG. 1 is configured to manage history information that indicates the processing history with respect to a user A.

Referring to FIG. 1A, the legitimacy management system 1 includes a user device 3 (an example of a “user device” in the present claims), distribution devices 5₁ and 5₂ (an example of “distribution devices” in the present claims) (in some cases, each appended suffix will be omitted), and an exchange apparatus 7 (an example of an “exchange apparatus” in the present claims). The user device 3 is used by the user A. The distribution devices 5 are used by one or more other users. The user device 3 and the distribution devices 5 each operate under management of the exchange apparatus 7.

For example, the user device 3 and the distribution device 5 may each be configured as an information processing device to be used by an individual user such as a smartphone, personal computer, or the like. By employing a program or the like, this arrangement allows such an information processing device to provide both the user device function and the distribution device function. In relation to the user of the information processing device, the information processing device can be regarded as the user device. In relation to other users, the information processing device can be regarded as the distribution device. The exchange apparatus 7 is configured as a server, for example. For simplification of description, description will be made regarding an example including a single user device 3, a single exchange apparatus 7, and two distribution devices 5.

Referring to FIG. 1B, the user device 3 includes a privileged split file storage unit 13, a processing unit 17 (an example of a “processing unit” in the present claims), a user-side hash value calculation unit 19, a splitting unit 21 (an example of a “splitting unit” in the present claims), a user-side authentication unit 23, and a communication unit 25.

Referring to FIG. 1C, the distribution device 5 includes an ordinary split file storage unit 31 (an example of a “split file storage unit” in the present claims), a processing unit 33, and a communication unit 35.

Referring to FIG. 1D, the exchange apparatus 7 includes a device information storage unit 41, a processing unit 47, an exchange-side hash value calculation unit 49, a combining unit 51 (an example of a “combining unit” in the present claims), an exchange-side authentication unit 53 (the user-side authentication unit 23 and the exchange-side authentication unit 53 are examples of an “authentication unit” in the present claims), and a communication unit 55.

Referring to FIGS. 2A and 2B, description will be made regarding processing in which the history information is split so as to perform distribution processing.

The splitting unit 21 splits the history information in a secret-sharing manner using a method described in Patent document 1 or the like, for example, thereby providing multiple split files (Step STD1).

Examples of the history information include: a message record that records all messages sent from users via their user devices; a ledger (time-stamped historical information with respect to a transaction (sending/receiving) in a cryptocurrency application); etc. The user device 3 stores the history information in its main storage apparatus, for example.

The split files include a privileged split file and an ordinary split file. The privileged split file and the ordinary split file are each configured as a piece obtained by splitting the history information using the method described in Patent document 1. The privileged split file has a data structure that allows the combining unit 51 to use it only once to perform combining processing. The ordinary split file is configured as a piece that allows the combining unit 51 to use it multiple times to perform combining processing (see Patent document 1). The privileged split file is stored in the user device 3. The ordinary split file is stored in each distribution device 5.

The splitting unit 21 performs distribution processing (Step STD2). Specifically, the splitting unit 21 stores the privileged split file in the privileged split file storage unit 13. The splitting unit 21 queries the exchange apparatus 7 via the communication unit 25 with respect to the distribution device to be selected as a device to store the ordinary split file. The device information storage unit 41 of the exchange apparatus 7 stores information with respect to the user devices and the distribution devices under management. Based on the information with respect to the distribution devices stored in the device information storage unit 41, the processing unit 47 searches the distribution devices under management for a user device judged to have no relation with the user A, and employs the user device thus detected as the distribution device 5₁. The processing unit 47 instructs the device information storage unit 41 to manage the distribution device 5₁ selected as a device that stores the ordinary split file for the user device 3. Furthermore, the processing unit 47 provides the user device 3 with information via the communication unit 55 for identifying the distribution device 5₁. The splitting unit 21 sends the ordinary split file to the distribution device 5₁ via the communication unit 25. The processing unit 33 of the distribution device 5₁ stores onto storage unit 31 the ordinary split file received via the communication unit 35. The ordinary split file storage unit 31 is configured as an auxiliary storage device. Even after the processing, this allows the information to be non-volatile.

It should be noted that, in the splitting processing supported by the splitting unit 21, the number of split files and the number of pieces used in combining can each be designed as desired. For example, giving consideration to a case in which a storage medium of a different user becomes inaccessible (due to communication contract cancelation, etc.) or the like, it is conceivable that the number of pieces to be used in combining may be set to 3 to 5, and the number of split files may be set to 20 to 30 for safety. In contrast, the privileged split file is required every time the combining of the history information is requested. Accordingly, the number of privileged split files to be generated beforehand may be 10 to 20. It should be noted that, in a case where all privileged split files are to be used up, then re-splitting may preferably be performed using the last privileged split file.

Description will be made regarding an example using the technique described in Patent document 1 assuming that the number of pieces used in combining is 2, and the number of split files is 10, with the combinations of the ten split cyphertexts E₁, . . . , E₁₀ and split keys K₁ and K₂ as S_{q} (q=1, . . . , 10). In this example, each combination is designed such that S₁=(E₁, K₁), and S_{q}=(E_{q}, K₂) (q=2, . . . , 10). For example, S₁ is employed as the ordinary split file. The privileged split file is generated by providing S_{q} (q=2, . . . , 10) with a data structure that allows the combining unit 51 to use it only once for combining processing. Such a data structure that allows the combining unit to use it only once for combining processing can be supported using a counter, flag, semaphore, or the like, for example. Description will be made regarding an example using a flag. In this example, the combining unit 51 receives one of the privileged split files S_{q} from the user device 3, and receives the ordinary split file S₁ from the distribution device 5, and combines the privileged split file S_{q} and the ordinary split file S₁ thus received. The combining unit 51 switches the flag for the privileged split file thus used from the unused state to the used state. The combining unit 51 does not use a privileged split file having the flag set to the used state to perform the combining processing. This prevents the privileged split file from being used again after use. That is to say, this prevents the privileged split file from being used twice or more.

Description will be made with reference to FIGS. 2C through 2F regarding updating processing for the history information.

Referring to FIGS. 2C and 2F, when new payment processing or the like is performed as described in Non-patent document 1, for example, the processing unit 17 of the user device 3 makes an authentication request beforehand to the exchange apparatus 7 for judgment regarding whether or not the new processing is legitimate (Step STN1). The exchange-side authentication unit 53 judges whether or not the new processing to be executed by the user A is legitimate (Step STN2). For example, when the new processing is payment of cryptocurrency, the processing unit 17 compares the payment amount with the latest balance of the user A. When the user A possesses an amount of cryptocurrency that is equal to or greater than the payment amount, the exchange-side authentication unit 53 judges that this processing is legitimate. Otherwise, the exchange-side authentication unit 53 judges that this processing is not legitimate. With this arrangement, the exchange apparatus 7 holds information that indicates the latest balance of the user A. However, the exchange apparatus 7 holds no history information thereof. When the exchange-side authentication unit 53 has judged that this processing is legitimate, the exchange-side authentication unit 53 notifies the user device 3 of this information, following which the flow proceeds to Step STN3. When the exchange-side authentication unit 53 judges that this processing is not legitimate, the exchange-side authentication unit 53 executes error processing (Step STN14) in which the user device 3 is informed that the new processing to be executed is not legitimate, following which the processing ends.

Referring to FIGS. 2D and 2F, in Step STN3, the processing unit 17 of the user device 3 sends one privileged split file to the exchange apparatus 7, and makes a request for performing the combining processing. The combining unit 51 makes reference to the device information storage unit 14 to obtain information on the distribution device 5₁ and then makes a request to the distribution device 5₁ to send back the ordinary split file. The processing unit 33 of the distribution device 5₁ sends the ordinary split file to the exchange apparatus 7 (Step STN4). The combining unit 51 performs decrypting and combining processing using the privileged split file and the ordinary split file, so as to obtain the combined file (Step STN5). The exchange-side hash value calculation unit 49 acquires an exchange-side hash value (first hash value) with respect to the combined file. The exchange-side authentication unit 53 performs authentication processing for the exchange-side hash value (Step STN6). Specifically, the exchange-side authentication unit 53 stores another exchange-side hash value (second hash value) calculated in the previous combining processing (see Step STN15). The exchange-side authentication unit 53 compares the first hash value with the second hash value. When the first hash value and the second hash value are the same, the exchange-side authentication unit 53 judges that this processing is legitimate (there has been no falsification since the previous combining processing). Otherwise, the exchange-side authentication unit 53 judges that this processing is not legitimate. It should be noted that, when the exchange-side hash value is calculated for the user A for the first time, judgment is preferably made based on a comparison result with the initial value.

After the exchange-side authentication unit 53 judges that the exchange-side hash values are same and is legitimate, the processing unit 47 searches the distribution devices under management so as to select a new distribution device 5₂. Subsequently, the processing unit 47 notifies the user device 3 of the combined file and the information for identifying the new distribution device 5₂ (Step STN7). The user-side hash value calculation unit 19 calculates the hash value of the combined file thus received. The user-side authentication unit 23 judges whether or not the hash value thus calculated matches another user-side hash value (see Step STN10) calculated in the previous processing (Step STN8). When the hash values are the same, judgement is made that there has been no falsification since the previous processing, following which the flow proceeds Step STN9. Otherwise, as error processing (Step STN14), the user-side authentication unit 23 sends a notice that there is a falsification in the combined file, following which the processing ends.

It should be noted that the user-side authentication unit 23 or the exchange-side authentication unit 53 may repeat the combining processing while changing the combination of the privileged split file and the ordinary split file. If a legitimate combination cannot be obtained after the combining processing is repeated as described above, judgment may be made that falsification has occurred since the previous processing.

Referring to FIGS. 2E and 2F, in Step STN9, the processing unit 17 of the user device 3 performs new processing such as a payment or the like, and adds a history of the new processing to the combined file, which is employed as new history information (latest history information). Here, in addition to simple addition of a new message to the history information, the history information may be updated giving consideration to a history over a predetermined volume or over a predetermined period of time. The user-side hash value calculation unit 19 calculates the user-side hash value for the new history information (Step STN10). The splitting unit 21 acquires multiple new split files with respect to the new history information in a secret-sharing manner (Step STN11), and performs distribution processing (Step STN12). Specifically, the splitting unit 21 stores the new privileged split file in the privileged split file storage unit 13. The processing unit 33 of the distribution device 5₂ stores the new ordinary split file in the ordinary split file storage unit 31.

The processing unit 17 of the user device 3 sends the privileged split file to the exchange apparatus 7 so as to make an authentication request for the combining processing (Step STN13). The exchange-side authentication unit 53 judges whether or not the combining unit 51 is able to perform the combining processing after it receives the ordinary split file from the distribution device 5₂. When judgment has been made that the combining processing can be performed, the exchange-side hash value calculation unit 49 calculates a hash value with respect to the new combined file thus obtained by the combining processing (Step STN15), following which the processing ends. When judgment has been made that the combining processing can not be performed, i.e., when judgment has been made that it is not legitimate, the exchange-side authentication unit 53 performs error processing (Step STN14). That is to say, the exchange-side authentication unit 53 notifies the user-side device 3 that the combining processing cannot be performed, following which the processing ends.

The user-side hash value (see Step STN10) and the exchange-side hash value (see Step STN15) thus calculated are used in the subsequent authentication processing (see Steps STN6 and STN8). Accordingly, the user-side hash value and the exchange-side hash value are stored in an auxiliary storage apparatus or the like. Furthermore, the amount of cryptocurrency possessed by the user A or the like is also used in the authentication judgement for the next new processing (Step STN2). Accordingly, such information is also stored in the auxiliary storage apparatus or the like.

### EXAMPLE 2

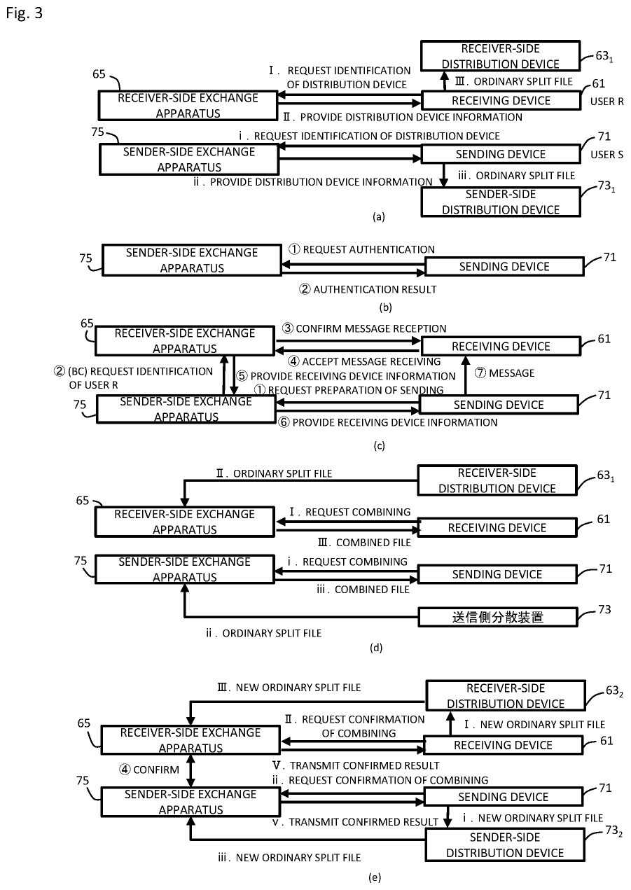

Description will be made regarding an example of management of the history information in the information processing with respect to multiple users. Specific description will be made with reference to FIG. 3 regarding an example in which the user S sends a message to a user N. It should be noted the processing performed by each apparatus is supported by each processing unit of each apparatus unless otherwise noted, for example.

In FIG. 3, as the user devices, a legitimacy management system includes a sending device 71 to be used by the user S and a receiving device 61 to be used by the user R. As the distribution devices, the legitimacy management system includes a sender-side distribution device 73 and a receiver-side distribution device 63. As the exchange apparatuses, the legitimacy management system includes a sender-side exchange apparatus 75 and a receiver-side exchange apparatus 65. Each user device, each distribution device, and each exchange apparatus have the same configurations as those shown in FIGS. 1B, 1C, and 1D, respectively.

The sending device 71 and the sender-side distribution device 73 are managed by the sender-side exchange apparatus 75. On the other hand, the receiving device 61 and the receiver-side distribution device 63 are managed by the receiver-side exchange apparatus 65.

Referring to FIG. 3A, description will be made regarding the distribution processing supported by the sending device 71 and the receiving device 61. The sending device 71 and the receiving device 61 each perform splitting processing on the history information in the same manner as shown in FIGS. 2A and 2B. The sending device 71 and the receiving device 61 each store their privileged split file in the device itself. Furthermore, the sending device 71 and the receiving device 61 respectively query the sender-side exchange apparatus 75 and the receiver-side exchange apparatus 65 with respect to the distribution devices to be selected. Subsequently, the sending device 71 and the receiving device 61 respectively instruct a sender-side distribution device 73₁ and a receiver-side distribution device 63₁, which are each selected as a result of the queries, to store the respective ordinary split files.

Description will be made with reference to FIGS. 3B through 3E regarding information processing in which the sending device 71 sends a message to the receiving device 61.

Referring to FIG. 3B, the user S of the sending device 71 operates the sending device 71 in order to send a message to the user R. The sending device 71 issues a request to the sender-side exchange apparatus 75 for prior confirmation for sending of a message to the user R (see Step STN1 in FIG. 2). The exchange-side authentication unit of the sender-side exchange apparatus 75 checks beforehand the content of the message of the user S, and judges whether or not the sending of the message is legitimate (see Step STN2 in FIG. 2). When judgment has been made that the sending of the message is not legitimate, the sender-side exchange apparatus 75 notifies the sending device of this information.

Referring to FIG. 3C, when judgment has been made that the sending of the message is legitimate, the sending device 71 issues a request to the sender-side exchange apparatus 75 to prepare for message sending. The sender-side exchange apparatus 75 broadcasts a request to other exchange apparatuses included in the legitimacy management system to return a response if a particular receiver-side exchange apparatus manages the receiving device 61 of the user R (request for returning a notice of contact information with respect to the user R). It should be noted that the contact information with respect to the exchange apparatuses is managed by an unshown central server. When a given exchange apparatus does not manage the user device used by the user R, the exchange apparatus may either send a notice that it does not manage this user device, or may send no notice at all.

When the receiver-side exchange apparatus 65, that manages the receiving device 61, receives a contact information notice request for the user R, it queries the receiving device 61 whether or not the receiving device 61 allows to receive the message from the user S. When the receiving device 61 allows receiving of the message, the receiving device 61 notifies the receiver-side exchange apparatus 65 of this information (see Step STN1 in FIG. 2). Upon receiving a notice from the receiving device 61 that the message is to be received, the receiver-side exchange apparatus 65 judges that the message-receiving processing of the receiving device 61 is legitimate (see Step STN2 in FIG. 2), and notifies the sender-side exchange apparatus 75 of the contact information with respect to the user R, i.e., the contact information with respect to the receiving device 61 (the address or the like to be used by the sending device 71 to send a message to the receiving device 61).

If the sender-side exchange apparatus 75 has not acquired the information with respect to the user device used by the user R after a predetermined period of time elapses, or when the receiving device 61 rejects the reception, the sender-side exchange apparatus 75 informs the sending device 71 that the sending device 71 cannot send a message to the receiving device 61.

Upon receiving the contact information with respect to the receiving device 61 from the receiver-side exchange apparatus 65, the sender-side exchange apparatus 75 judges whether the message sending processing of the sending device 71 is legitimate or not, and if it is, sends the contact information with respect to the receiving device 61 to the sending device 71. The sending device 71 sends a message to the receiving device 61 using the contact information with respect to the receiving device 61 thus received. As a result, the receiving device 61 receives the message. After the receiving device 61 receives the message, the receiving device 61 sends an Ack to the receiver-side exchange apparatus, thereby notifying the receiver-side exchange apparatus of the completion of the message reception.

Referring to FIG. 3D, in addition to the sending of an acknowledgement notice for message reception to the receiver-side exchange apparatus 65, the receiving device 61 sends the privileged split file so as to request the combining processing (see Step STN3 in FIG. 2). The receiver-side exchange apparatus 65 receives the ordinary split file from the receiver-side distribution device 63₁, and performs the combining processing. If there has been no falsification, the receiver-side exchange apparatus 65 sends the combined file to the receiving device 61 (see Steps STN4 through STN6 in FIG. 2).

Referring to FIG. 3E, after the receiving device 61 confirms that there has been no falsification of the combined file, the receiving device 61 adds the history of the message-receiving processing to the combined file so as to obtain the new history information. Furthermore, the receiving device 61 performs the splitting processing on the new history information thus obtained, and stores the new ordinary split file in the receiver-side distribution device 63₂ thus obtained (see Steps STN7 through STN12). The receiver-side exchange apparatus 65 confirms whether or not the combining processing can be performed. The receiver-side exchange apparatus 65 notifies the sender-side exchange apparatus 75 of the result thereof (see Steps STN13 through STN15)

Referring to FIG. 3D, in addition to the sending of the message authentication confirmation request to the sender-side exchange apparatus 75, the sending device 71 sends the privileged split file to the sender-side exchange apparatus 75 to request the combining processing (see Step STN3 in FIG. 2). The sender-side exchange apparatus 75 requests and receives the ordinary split file from the sender-side distribution device 73₁ so as to perform the combining processing. If there has been no falsification, the sender-side exchange apparatus 75 sends the combined file to the sending device 71 (see Steps STN4 through STN6 in FIG. 2).

Referring to FIG. 3E, after the sending device 71 confirms that there has been no falsification of the combined file, the sending device 71 adds, to the combined file, the history of the message-sending processing in which a message has been sent to the receiving device 61, so as to obtain the new history information. Furthermore, the sending device 71 performs the splitting processing on the new history information, and stores the new ordinary split file in the sender-side distribution device 73₂ (see Steps STN7 through STN12). The sender-side exchange apparatus 75 confirms whether or not the combining processing can be performed. Subsequently, when the sender-side exchange apparatus 75 receives a notice that the receiver-side exchange apparatus 65 is able to perform the combining processing, and when the sender-side exchange apparatus 75 is also able to perform the combining processing, the sender-side exchange apparatus 75 notifies the receiver-side exchange apparatus 65 of the result thereof (see Steps STN13 through STN15), and sends a notice to the sending device 71 that the processing is legitimate.

Upon receiving a notice that the sender-side exchange apparatus 75 is able to perform the combining processing, the receiver-side exchange apparatus 65 sends a notice to the receiving device 61 that the processing is legitimate.

As described above, the legitimacy of the processing history involving multiple user devices is judged by each of the exchange apparatuses that support the respective user devices. If all the corresponding exchange apparatuses judge that it is legitimate, judgement may be made that the processing involving the multiple user devices is legitimate.

In order to check collusion between the user device and the exchange apparatus shown in FIGS. 1 and 2, and further, collusion among the sending device, the sender-side exchange apparatus, the receiving device and the receiver-side exchange apparatus shown in FIG. 3, a so-called certificate authority, which is employed in the Public Key Infrastructure (PKI) technique, may be employed.

Description will be made assuming that the certificate authority is a fair authority. For convenience of description from the mechanism viewpoint, a so-called private key actually operates as a public key, and will be referred to as “PrvKey”. In contrast, a so-called public key actually operates as a private key, and will be referred to as “PubKey”.

Upon receiving a request from a member registered beforehand to generate a private key and a public key, the certificate authority generates the public key (PubKey) based on a private key (PrvKey) having parameters of which a part is generated based on the information sent from the member. Subsequently, the certificate authority returns the public key (PubKey) to the member. On the other hand, the private key (PrvKey) is stored in the certificate authority in order to support other members when they make a public request. That is to say, the private key (PrvKey) is to be available to the public. Accordingly, the private key (PrvKey) corresponds to a so-called public key employed in typical systems. However, the private key (PrvKey) actually operates as a “private key” in this system. On the other hand, the public key (PubKey) corresponds to a so-called private key in the BTC technique. The member encrypts the transaction using the public key (PubKey), and sends the encrypted transaction to a payment destination (recipient) via the P2P network. The recipient makes a request to the certificate authority to search for the ID of the remitter, and to send the private key (PrvKey) of the remitter. The recipient is also a user that has been registered beforehand in the certificate authority. Accordingly, a log remains with respect to the name of a member that has requested the private key (PrvKey) and with respect to whether or not the private key (PrvKey) has been disclosed. The recipient is able to decrypt the transaction using the private key (PrvKey) transmitted from the certificate authority, thereby allowing the recipient to read the transaction. The private key (PrvKey) and the public key (PubKey) are issued for each transaction, and are each configured as a single-use key.

As described above, in a case in which such handling is performed for all the members from the first transaction, the certificate authority checks whether or not each transaction is operated within the range of the balance, and updates the private key (PrvKey) including the balance information. By storing the log, the certificate authority is capable of tracking the change in the balance for each member. When any member attempts to perform falsification of past processing, the certificate authority is capable of re-confirming such processing. In addition, in a case in which a request to disclose a private key (PrvKey) is stored in the form of a log, this arrangement allows the certificate authority to accumulate information with respect to the members involved in each processing and with respect to the kind of each processing.

Also, an arrangement may be made configured to allow the user to select an “electronic notary” for the user himself/herself, and to allow the user to entrust a will of the user to the electronic notary thus selected. Here, the entrusting of the user's will means that, when communication has been lost for a predetermined period of time or the like, an instruction is entrusted to the electronic notary to execute processing with respect to the user's assets (delivery of the user's assets to a person designated by the user, donation, or the like). The user entrusts the latest location information, the privileged split file, and the content of entrusted processing to the electronic notary. The electronic notary calls the user device, and checks whether or not it is able to contact the user device. In a case in which the electronic notary has lost contact with the user for a predetermined period of time, the electronic notary executes the processing thus entrusted.

In a case in which such an electronic notary is employed, this arrangement allows the user to automatically transfer the balance of the user's account to another account of the user himself/herself, or otherwise to an account of an heir of the user even if the user's account is set to a dormant state (account dormancy state). Also, a period of time from the user's account coming to be in the dormant state (account dormancy state) up to the execution of the will may be set to a shortened period of time. In this case, if a malfunction has occurred in the user device, for example, this arrangement allows the user's account and the user device to be immediately switched.

In order to allow the “electronic notary” to execute such processing, the user may preferably make settings at the start time of the processing such that, in the distribution processing (Steps STD2, STN12, or the like in FIG. 2), the privileged split file is entrusted to the “electronic notary” in addition to storing the privileged split file in the user device itself.

It should be noted that description has been made with reference to FIG. 3 regarding an example in which (b) a message prior confirmation request and (c) a sending preparation request or the like are issued at different timings. Also, such requests may be issued at the same time. With such an arrangement, when judgment has been made in the message prior confirmation that the processing is legitimate, the sender-side exchange apparatus 75 may execute the sending preparation or the like after the message prior confirmation.

### EXAMPLE 3

As described with reference to FIG. 3, the present invention can be regarded as an arrangement that provides safe message sending/receiving. Furthermore, the present invention is applicable to a system that manages cryptocurrency. Description will be made regarding such an example. This allows an essential difference between the present invention and the technique described in Non-patent document 1 to be clearly understood.

The “exchange” and “member” described in Non-patent document 1 correspond to the “exchange apparatus” and “user” in the present invention, respectively. The essential difference between them is that the “exchange apparatus” according to the present invention also provides the authentication function. Furthermore, the secret sharing engine includes a “splitting engine” and a “combining engine”, which are operated as a separate entity.

As a central administrator, a community server (not shown in the drawings) is provided as a management base. This arrangement allows the user to be registered in the exchange apparatus, and to download from the community server a client-side application software (wallet software) for a device (client) to be used by the user himself/herself. It should be noted that, in such an arrangement, the user may prove his/her identity or the like before the user is registered in the exchange apparatus. Furthermore, all the exchange apparatuses register themselves (their locations) in the community server. This allows each exchange apparatus to communicate with another exchange apparatus via a P2P communication system.

The wallet software allows each device used by each user to function as the user device and the distribution device. The users are allowed to provide (rent out) their own storage (the capacity of the storage device provided in their own respective user devices) to each other. The management base may pay a storage charge to the user for the storage to be rented out. It should be noted that each client is evaluated by the exchange at all times. For example, each user is assigned evaluation points with respect to response speed, data transfer rate, storage capacity, infrequent downtime, etc. Each client contributes its storage to another client mainly in the vicinity of the client itself. Each user device uses the storage of the distribution device mainly in the vicinity of the user device itself. Here, vicinity is defined as one client being close to another client, and we call them to be in the vicinity. The “vicinity” is defined by the distance from the viewpoint of IP address, the physical distance between them, the access speed from an exchange apparatus, file transfer rate, etc.

An exchange of cryptocurrency (sending and receiving cryptocurrency) is referred to as a “transaction”. The chronological history information with respect to the transaction is referred to as a “ledger”. From the viewpoint of a database, each transaction corresponds to a record. Furthermore, a ledger that collects a set of records corresponds to a database.

Referring to FIG. 3, the sender-side exchange apparatus 75 and the receiver-side exchange apparatus 65 hold the current balance of cryptocurrency possessed by the user S and the user R, respectively. However, the sender-side exchange apparatus 75 and the receiver-side exchange apparatus 65 are not required to hold the histories thereof.

The sending device 71 enters a preparation step for generating a message (transaction). The sending device 71 sends the following information to the sender-side exchange apparatus 75. The information includes: an identifier of the receiving device 61 who becomes the beneficiary to the transaction; an amount of money to be transferred; a privileged split file (one-time privileged piece) to be used to perform the combining processing; and the number of the distribution devices to be used to store the updated ordinary split files in the form of split files.

The sender-side exchange apparatus 75 performs the combining processing using the one-time privileged piece sent from the sending device 71. Furthermore, the sender-side exchange apparatus 75 calculates the hash value of the combined result, and compares the hash value thus calculated with the hash value stored from the previous processing. When they match (which indicates that there has been no falsification after the previous processing), the sender-side exchange apparatus 75 checks whether or not the balance is sufficient for the amount of money to be remitted. When the balance is insufficient, the sender-side exchange apparatus 75 returns error information to the sending device 71. At the same time, the sender-side exchange apparatus 75 seeks for requested number of distribution devices in the vicinity, checks whether the storage capacity is sufficient, from among the “highest evaluation point” devices, and its IP address.

The sender-side exchange apparatus 75 queries all the exchange apparatuses with respect to the location (IP address) of the receiving device 61. The receiver-side exchange apparatus 65, which manages the receiving device 61 as a member thereof, notifies the sender-side exchange apparatus 75 of information that “the receiving device 61 is a member managed by the receiver-side exchange apparatus 65 itself”.

Upon receiving a notice from the receiver-side exchange apparatus 65 that the receiving device 61 is a member of the receiver-side exchange apparatus 65 itself, the sender-side exchange apparatus 75 sends the following information to the receiver-side exchange apparatus 65. Such information includes: receiving an information disclosure request (to be used for remittance) from the sending device 71; the name and IP address of the sending device 71; and the current balance of the sending device 71 and the amount of money to be remitted. Upon receiving this information, the receiver-side exchange apparatus 65 notifies the receiving device 61 of this information.

The receiving device 61 receives this information. When judgment is made that the receiving device 61 is to receive the money to be remitted, the receiving device 61 sends the following information to the sending device 71. Such information includes: the ID of the receiving device 61 itself, the current IP address, and the public key held by the receiving device 61 itself.

On the other hand, if the balance is sufficient, the sender-side exchange apparatus 75 sends the following information to the sending device 71. Such information includes: history information and IP addresses of the distribution devices (as many as requested) to be used to store new history information.

The sending device 71 calculates the hash value of the history information sent from the sender-side exchange apparatus 75. Furthermore, the sending device 71 compares the hash value thus calculated with the hash value stored from the previous processing. When they match (which indicates that there has been no falsification since the previous processing), the sending device 71 checks the balance. When judgment is made that the balance is sufficient, the sending device 71 generates a transaction (message). Furthermore, the sending device 71 encrypts the transaction using the public key held by and sent from the receiving device 61, and directly sends the encrypted transaction to the receiving device 61 (the IP address thereof). Upon receiving the transaction (message), the receiving device 61 decrypts the encrypted transaction, and confirms the content of the transaction. When judgment has been made that the balance thus received is sufficient, the receiving device 61 returns a reception message to the sending device 71.

After the sending device 71 confirms the reception message received from the receiving device 61, the sending device 71 adds the current transaction to the history information. Furthermore, the sending device 71 calculates the hash value of the new history information, and stores the hash value in the sending device 71 itself. With such an arrangement, the history information is managed in a secret-sharing manner. In this stage, the sending device 71 generates an appropriate number of one-time privileged pieces, and stores the one-time privileged pieces in the sending device 71 itself.

Upon receiving a message, the receiving device 61 adds the current transaction to the history information. Furthermore, the receiving device 61 calculates the hash value of the new history information, and stores the hash value in the receiving device 61 itself. With such an arrangement, the history information is managed in a secret-sharing manner. In this stage, the receiving device 61 generates an appropriate number of one-time privileged pieces, and stores the one-time privileged pieces in the receiving device 61 itself.

Upon receiving the privileged piece from the receiving device 61, and upon receiving a combining processing confirmation request, the receiver-side exchange apparatus 65 confirms whether or not the combining processing can be performed. When judgment has been made that the combining processing can be performed, the receiver-side exchange apparatus 65 verifies whether or not the hash value of the combined result is the same as the hash value calculated from the previous processing. Subsequently, the receiver-side exchange apparatus 65 notifies the sender-side exchange apparatus 75 of the verification result. Upon receiving the privileged piece from the sending device 71, and upon receiving a combining processing verification request, the sender-side exchange apparatus 75 performs the following processing. That is to say, when judgment has been made that the combining processing can be performed, the sender-side exchange apparatus 75 verifies whether nor not the hash value of the combined result is the same as the hash value calculated from the previous processing, i.e., whether or not the processing is legitimate. Furthermore, upon receiving a notice of the verification result from the receiver-side exchange apparatus 65 that the processing is legitimate, the sender-side exchange apparatus 75 sends its verification result to the receiver-side exchange apparatus 65.

It should be noted that, by employing the content of the message as a transaction condition (payment authorization condition), this arrangement allows the condition to be verified by the message sender-side exchange apparatus and the message receiver-side exchange apparatus from the viewpoint of an arbitrator. This allows a letter of credit (L/C) transaction conventionally guaranteed between banks (between a bank that issues a L/C and a bank that receives a L/C) to be digitized and replaced by an electronic transaction (cryptocurrency system).

For example, in FIG. 3, the sender-side exchange apparatus 65 performs the combining processing so as to generate a ledger for the receiving device 61, thereby updating the ledger. This finalizes the transfer of funds. In this stage, the transaction initiated by the sending device 71 is completed. If a problem has occurred (e.g., wrong product delivery, delay in delivery, etc.), the sender-side exchange apparatus 75 and the receiver-side exchange apparatus 65 may function as arbitrators in order to make judgement. Also, another arbitrator may be selected as a third party, and judgment may be made by a majority vote. As described above, such an arrangement enables settlement via cryptocurrency while maintaining conventional business practices.

As described above, this arrangement may function as a substitution of a conventional letter of credit transaction. Furthermore, when there is a difference in opinion between a buyer and a seller, this arrangement is capable of supporting arbitration. If judgment has been made that “a condition has not been not satisfied”, i.e., that the sales contract has fallen through, such a mechanism suspends the transfer of funds, thereby canceling the payment. Furthermore, in an ordinary mail-order system, such an arrangement employs an intermediary (escrow), thereby supporting a “safe transaction system via cryptocurrency”.

### REFERENCE SIGNS LIST

1 legitimacy management system, 3 user device, 5 distribution device, 7 exchange apparatus, 13 privileged split file storage unit, 17 processing unit, 19 user-side hash value calculation unit, 21 splitting unit, 23 user-side authentication unit, 25 communication unit, 31 ordinary split file storage unit, 33 processing unit, 35 communication unit, 41 device information storage unit, 47 processing unit, 49 exchange-side hash value calculation unit, 51 combining unit, 53 exchange-side authentication unit, 55 communication unit, 61 receiving device, 63 receiver-side distribution device, 65 receiver-side exchange apparatus, 71 sending device, 73 sender-side distribution device, 75 sender-side exchange apparatus.

1. A legitimacy management system configured to manage history information that indicates a processing history with respect to a user, wherein the legitimacy management system comprises:
a user device;
a distribution device;
an exchange apparatus; and
an authentication unit,
wherein the user device comprises:
a splitting unit configured to split the history information so as to acquire a plurality of split files; and
a processing unit configured to issue a combining request for instructing the exchange apparatus to perform combining processing,
wherein the distribution device comprises a split file storage unit configured to store a part or all of the plurality of split files,
wherein the exchange apparatus comprises:
a combining unit configured to receive at least one split file from the distribution device, and to perform combining processing of a part or all of the plurality of split files so as to acquire a combined file, according to the combining request,
wherein the authentication unit judges whether or not falsification has occurred in the combined file in a period of time from the splitting processing up to the combining processing,
and wherein, when the authentication unit has judged that no falsification has been detected in the combined file, the processing unit adds a new processing history to the combined file, which is employed as new history information.

2. The legitimacy management system according to claim 1, wherein the user devices include a sending device configured to send a message and a receiving device configured to receive the message,
wherein the authentication unit verifies the message beforehand,
and wherein, when judgement has been made that the message is legitimate, the processing unit of the sending device sends the message, and adds a history of the message sending processing to the combined file that corresponds to the sending device, and the processing unit of the receiving device receives the message, and adds a history of the message receiving processing to the combined file that corresponds to the receiving device.

3. The legitimacy management system according to claim 1, wherein the plurality of split files include a privileged split file having a structure that allows the combining unit to use the privileged split file only once to perform the combining processing, and an ordinary split file that allows the combining unit to use the ordinary split file multiple times to perform the combining processing,
wherein the splitting unit stores a part or all of the ordinary split files in the distribution device, instructs the user device to hold the privileged split file, and instructs the distribution device not to hold the privileged split file,
and wherein the combining unit receives the privileged split file from the user device, receives at least one ordinary split file from the distribution device, and performs the combining processing using the privileged split file and at least one ordinary split file.

4. A legitimacy management method for managing history information that indicates a processing history with respect to a user, wherein the legitimacy management method comprises:
splitting in which a splitting unit included in a user device splits the history information so as to acquire a plurality of split files;
storing in which a split file storage unit included in a distribution device stores a part or all of the plurality of split files;
combined file acquiring in which a processing unit included in the user device issues a combining request for instructing an exchange apparatus to perform combining processing, a combining unit included in the exchange apparatus receives at least one split file from the distribution device, and performs combining processing of a part or all of the plurality of split files so as to acquire a combined file, according to the combining request; and
new history information generating in which an authentication unit judges whether or not falsification has occurred in the combined file in a period of time from the splitting processing up to the combining processing, and when the authentication unit has judged that no falsification has been detected in the combined file, the processing unit adds a new processing history to the combined file, which is employed as new history information.

5. A computer program configured to instruct a computer to function as a splitting unit according to claim 1, or as an authentication unit according to claim 1.
